(19) United States
(12) Patent Application Publication
(10) Pub. No.: US 2019/0359505 A1
(43) Pub. Date: Nov. 28, 2019

(54) PIPING DEVICE FOR IMPROVING EFFECTS OF IRRADIATING FLUID

(71) Applicant: PHOENIX OPTRONICS CORP., TAOYUAN CITY (TW)

(72) Inventor: REN-CHENG CHAO, TAOYUAN CITY (TW)

(21) Appl. No.: 16/417,877

(22) Filed: May 21, 2019

(30) Foreign Application Priority Data
May 28, 2018 (TW) 107206983

(51) Int. Cl. C02F 1/32

(52) U.S. Cl. CPC C02F 1/325; C02F 2201/3223

(57) ABSTRACT

A piping device for improving effects of irradiating fluid has a body, a passage module, and multiple light-emitting elements. The body has a cavity and multiple slits. The cavity is disposed inside the body. The multiple slits are disposed through the body at spaced intervals, and communicate with the cavity. The passage module has a transparent tube and a guiding component. The transparent tube is disposed in the cavity of the body. The guiding component is spiral, and is disposed in the transparent tube. The multiple light-emitting elements are mounted to the body in the multiple slits separately, and surround the passage module.

### BACKGROUND OF THE INVENTION

### 1. Field of the Invention

The present invention relates to a piping device, and more particularly to a piping device that can irradiate fluid flowing therethrough.

### 2. Description of Related Art

Rays of different wavelengths on a spectrum may have different impacts on animals, plants, or even microorganisms. For example, a visible light at a wavelength of 450 nanometers (nm) can stimulate algae's growing, and an ultraviolet (UV) or near-UV at 200 to 405 nm may be used for sterilization. Thus, rays of different wavelengths may be applied in daily life or industries for a variety of purposes such as cultivating, inhibiting, or sterilizing organisms in fluid.

A conventional piping device for irradiating fluid comprises a transparent tube and multiple light sources. The transparent tube is straight, and the multiple light sources are disposed around the transparent tube. Fluid flowing axially through the transparent tube may thereby be irradiated by a specific wavelength via the multiple light sources in order to cultivate, inhibit, or sterilize organisms in the fluid.

However, the fluid passes straight through the transparent tube of the conventional piping device for irradiating fluid, so irradiation time is too short to produce the effects mentioned above, and this may cause the fluid to fail to cultivate, inhibit, or sterilize the organisms.

### SUMMARY OF THE INVENTION

The main objective of the present invention is to provide a piping device for improving effects of irradiating fluid in order to prolong irradiation time, provide a variety of effects of irradiation, and thereby solve the shortcoming of the prior art.

The piping device for improving effects of irradiating fluid in accordance with the present invention comprises a body, a passage module, and multiple light-emitting elements. The body has a cavity and multiple slits. The cavity is disposed inside the body. The multiple slits are disposed through the body at spaced intervals, and communicate with the cavity. The passage module is disposed in the body and has a transparent tube and a guiding component. The transparent tube is disposed in the cavity. The guiding component is spiral, and is disposed in the transparent tube. The multiple light-emitting elements are mounted to the body in the multiple slits separately, and surround the passage module.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a piping device for improving effects of irradiating fluid in accordance with the present invention;

FIG. 2 is a perspective view in partial section of the piping device for improving effects of irradiating fluid in FIG. 1;

FIG. 3 is another perspective view in partial section of the piping device for improving effects of irradiating fluid in FIG. 1;

FIG. 4 is a side view in partial section of the piping device for improving effects of irradiating fluid in FIG. 1;

FIG. 5 is an exploded perspective view of the piping device for improving effects of irradiating fluid in FIG. 1; and

FIG. 6 is an operational perspective view in partial section of the piping device for improving effects of irradiating fluid in FIG. 1.

### DETAILED DESCRIPTION OF THE PREFERRED EMBODIMENT

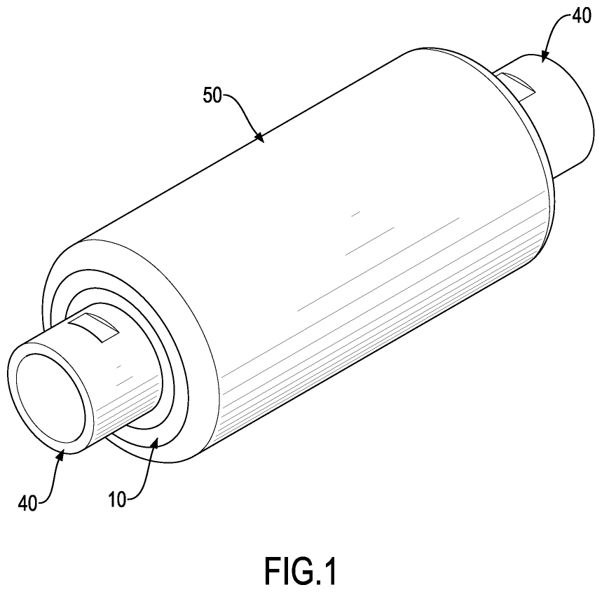

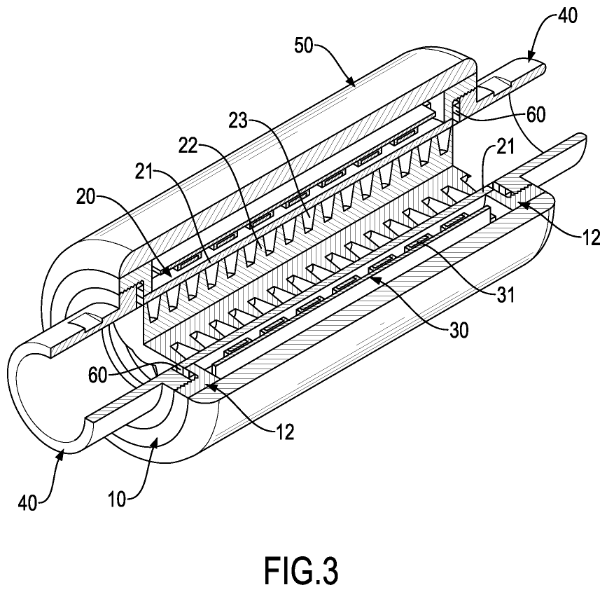

With reference to FIGS. 1, 2, 3, and 5, a piping device for improving effects of irradiating fluid in accordance with the present invention comprises a body 10, a passage module 20, multiple irradiation modules 30, two end stoppers 40, and a cover 50. In the present invention, four irradiation modules 30 are implemented.

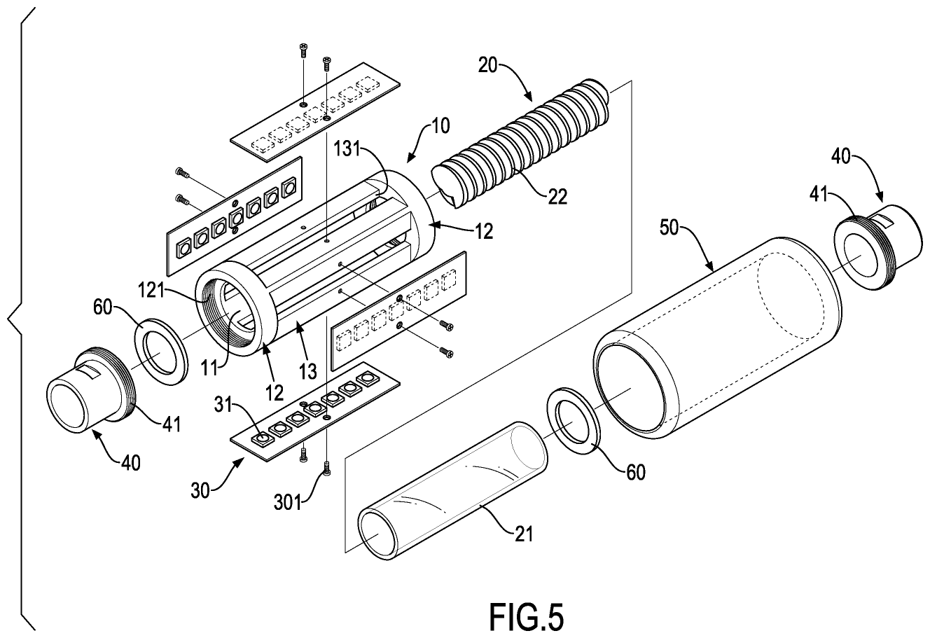

With reference to FIG. 5, the body 10 has a cavity 11, two connectors 12, and multiple assemblers 13. The cavity 11 is cylindrical, is disposed inside the body 10, and has a length and an inner diameter. Each one of the two connectors 12 is disposed at a respective one of two ends of the body 10, and is located on a respective one of two ends of the cavity 11. Each one of the two connectors 12 has an outer diameter and a recess 121. The recess 121 is disposed on the respective one of the two ends of the body 10, communicates with the cavity 11, and has an inner thread. In the present invention, four assemblers 13 are implemented. Each one of the four assemblers 13 extends in the lengthwise direction and forms a plane between the two connectors 12. Each one of the four assemblers 13 has a slit 131, which is disposed through a middle portion of the assembler 13, extends in the lengthwise direction, and communicates with the cavity 11 and an exterior of the body 10.

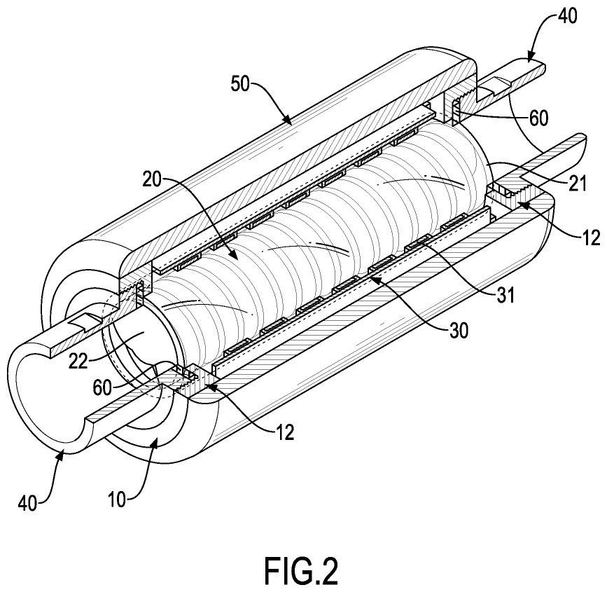

With reference to FIGS. 2 to 5, the passage module 20 is received and located in the body 10, and has a transparent tube 21 and a guiding component 22. The transparent tube 21 has a length and an outer diameter. The length of the transparent tube 21 matches the length of the cavity 11, and the outer diameter of the transparent tube 21 matches the inner diameter of the cavity 11, so the transparent tube 21 may fit in the cavity 11. The guiding component 22 is a spiral component disposed in the transparent tube 21, so as to produce a spiral passage 23 between the transparent tube 21 and the guiding component 22.

Preferably, the transparent tube 21 may be made of polycarbonate (PC), poly(methyl methacrylate) (PMMA), or glass. On the other hand, the guiding component 22 may be made of metal or plastic.

With reference to FIGS. 2 to 4, the four irradiation modules 30 are mounted to the body 10. Each one of the four irradiation modules 30 has multiple light-emitting elements 31. The multiple light-emitting elements 31 are aligned on a middle portion of the irradiation module 30. With reference to FIG. 5, each one of the four irradiation modules 30 is fixed to a respective one of the four assemblers 13 via two fixing units 301. The multiple light-emitting elements 31 of each one of the four irradiation modules 30 are thereby laid in the slit 131 of the corresponding assembler 13 and near the transparent tube 21. Preferably, the multiple light-emitting elements 31 are light-emitting diodes (LED). Moreover, the four irradiation modules 30 are electrically connected to a power source for driving the multiple light-emitting elements 31 to irradiate directional rays at a specific wavelength.

The multiple light-emitting elements 31 of each one, some, or all of the multiple irradiation modules 30 may also be a combination that can emit rays of different wavelengths, so as to provide a complex effect of cultivation, inhibition, sterilization, or any combination thereof.

With reference to FIGS. 2 to 5, the two end stoppers 40 are mounted to the body 10, and are respectively located on the two ends of the body 10. Each one of the two end stoppers 40 has a thread portion 41 to be screw-threaded with the inner thread of a respective one of the two connectors 12. The two end stoppers 40 are used to stop the passage module 20 from dropping out from the cavity 11 and entering into any one of the two recesses 121.

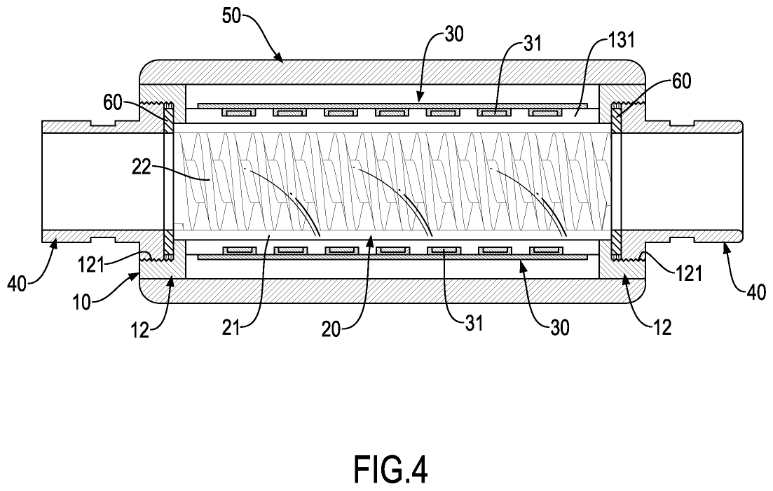

With reference to FIGS. 4 and 5, a gasket 60 is selectively disposed between the transparent tube 21 of the passage module 20 and each one of the two end stoppers 40 to prevent leakage.

The cover 50 sheathes the body 10. The cover 50 has a length equal to the length of the body 10, and has an inner diameter matching the outer diameters of the two connectors 12. Therefore, the cover 50 may sheathe the body 10 with two ends connected with the two connectors 12, respectively.

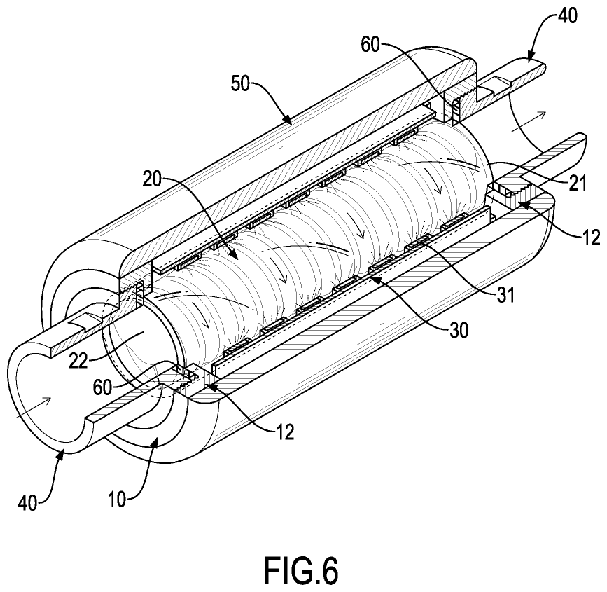

With aforementioned technical features and reference to FIG. 6, after fluid enters the piping device for improving effects of irradiating fluid from one of the two end stoppers 40, the fluid will flow spirally along the spiral passage 23 of the passage module 20 within the multiple irradiation modules 30. In comparison with flowing straight through, the spiral passage 23 retards flowing of the fluid so that the fluid may be irradiated for a longer time by the multiple light-emitting elements 31. As a result, a better effect of cultivation, inhibition, sterilization, or a combination of the three due to irradiation may be provided by the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A piping device for improving effects of irradiating fluid, the piping device comprising:
a body having
a cavity disposed inside the body; and
multiple slits disposed through the body at spaced intervals and communicating with the cavity;
a passage module disposed in the body and having
a transparent tube disposed in the cavity of the body; and
a guiding component being spiral, and disposed in the transparent tube; and
multiple light-emitting elements mounted to the body in the multiple slits separately, and surrounding the passage module.

2. The piping device for improving effects of irradiating fluid as claimed in claim 1, wherein
the body has two connectors located on two ends of the body respectively;
each one of the two connectors has a recess communicating with the cavity; and
the piping device further comprises two end stoppers screw-threaded with the two recesses of the two connectors.

3. The piping device for improving effects of irradiating fluid as claimed in claim 2, wherein the piping device further comprises two gaskets, and each one of the two gaskets is disposed between the passage module and a respective one of the two end stoppers.

4. The piping device for improving effects of irradiating fluid as claimed in claim 1, wherein
the body has multiple assemblers, each one of the multiple assemblers forming a plane; and
the piping device further comprises multiple irradiation modules, each one of the multiple irradiation modules mounted to a respective one of the multiple assemblers;
wherein each one of the multiple slits is disposed through a middle portion of a respective one of the multiple assemblers, and the multiple light-emitting elements are aligned on the multiple irradiation modules.

5. The piping device for improving effects of irradiating fluid as claimed in claim 2, wherein
the body has multiple assemblers, each one of the multiple assemblers forming a plane; and
the piping device further comprises multiple irradiation modules, each one of the multiple irradiation modules mounted to a respective one of the multiple assemblers;
wherein each one of the multiple slits is disposed through a middle portion of a respective one of the multiple assemblers, and the multiple light-emitting elements are aligned on the multiple irradiation modules.

6. The piping device for improving effects of irradiating fluid as claimed in claim 3, wherein
the body has multiple assemblers, each one of the multiple assemblers forming a plane; and
the piping device further comprises multiple irradiation modules, each one of the multiple irradiation modules mounted to a respective one of the multiple assemblers;
wherein each one of the multiple slits is disposed through a middle portion of a respective one of the multiple assemblers, and the multiple light-emitting elements are aligned on the multiple irradiation modules.

7. The piping device for improving effects of irradiating fluid as claimed in claim 4, wherein the transparent tube is made of polycarbonate, poly(methyl methacrylate), or glass, and the guiding component is made of metal or plastic.

8. The piping device for improving effects of irradiating fluid as claimed in claim 5, wherein the transparent tube is made of polycarbonate, poly(methyl methacrylate), or glass, and the guiding component is made of metal or plastic.

9. The piping device for improving effects of irradiating fluid as claimed in claim 6, wherein the transparent tube is made of polycarbonate, poly(methyl methacrylate), or glass, and the guiding component is made of metal or plastic.

10. The piping device for improving effects of irradiating fluid as claimed in claim 1, wherein the transparent tube is made of polycarbonate, poly(methyl methacrylate), or glass, and the guiding component is made of metal or plastic.

11. The piping device for improving effects of irradiating fluid as claimed in claim 7, wherein each one of the multiple light-emitting elements is a light-emitting diode.

12. The piping device for improving effects of irradiating fluid as claimed in claim 8, wherein each one of the multiple light-emitting elements is a light-emitting diode.

13. The piping device for improving effects of irradiating fluid as claimed in claim 9, wherein each one of the multiple light-emitting elements is a light-emitting diode.

14. The piping device for improving effects of irradiating fluid as claimed in claim 1, wherein each one of the multiple light-emitting elements is a light-emitting diode.

15. The piping device for improving effects of irradiating fluid as claimed in claim 4, wherein each one of the multiple light-emitting elements is a light-emitting diode.

16. The piping device for improving effects of irradiating fluid as claimed in claim 5, wherein each one of the multiple light-emitting elements is a light-emitting diode.

17. The piping device for improving effects of irradiating fluid as claimed in claim 6, wherein each one of the multiple light-emitting elements is a light-emitting diode.

18. The piping device for improving effects of irradiating fluid as claimed in claim 11, wherein the piping device further comprises a cover sheathing the body.

19. The piping device for improving effects of irradiating fluid as claimed in claim 12, wherein the piping device further comprises a cover sheathing the body.

20. The piping device for improving effects of irradiating fluid as claimed in claim 13, wherein the piping device further comprises a cover sheathing the body.
